(19) United States
(12) Patent Application Publication
(10) Pub. No.: US 2024/0300018 A1
(43) Pub. Date: Sep. 12, 2024

(54) PROCESS FOR MANUFACTURING AN ALUMINUM ALLOY PART BY LASER POWDER BED FUSION

(71) Applicant: COMMISSARIAT À L'ÉNERGIE ATOMIQUE ET AUX ÉNERGIES ALTERNATIVES, Paris (FR)

(72) Inventors: Mathieu Opprecht, Grenoble (FR); Jean-Paul Garandet, Grenoble (FR); Guilhem Roux, Grenoble (FR)

(21) Appl. No.: 18/551,052

(22) PCT Filed: Mar. 17, 2022
(86) PCT No.: PCT/FR2022/050480

§ 371 Date: Sep. 18, 2023

(30) Foreign Application Priority Data
Mar. 19, 2021 (FR) 2102756

(51) Int. Cl. B22F 10/28; B22F 9/08; B33Y 10/00; C22C 21/00

(52) U.S. Cl. CPC B22F 10/28; B22F 9/082; B33Y 10/00; C22C 21/00; B22F 2301/052; B22F 2998/10

(57) ABSTRACT

A process for manufacturing which comprises the following steps: a) supplying an aluminium alloy particle powder, b) applying a layer of powder to a solid substrate or to an underlying powder layer, c) locally melting the applied powder layer by laser beam scanning, to form a molten bath comprising a first surface in contact with the substrate or the underlying powder layer, d) cooling the molten bath at a cooling rate Vr to solidify it, where zirconium has been added before step c), the zirconium representing at least 0.7% by mass, relative to the total mass of the aluminium alloy, and the cooling rate Vr at the start of solidification at the first surface of the molten bath being: —less than Vrmax=w*9.106-4.106 where w is the percentage by mass of zirconium, and—strictly greater than Vrmin=106 K/s.

### TECHNICAL FIELD

The present invention relates to the general field of manufacturing parts made of aluminium alloy by additive manufacturing, and more particularly by a laser powder bed fusion (LPBF) process.

The invention relates to a process for manufacturing parts made of aluminium alloy.

The invention is particularly interesting since it allows addressing the problems of hot cracking of aluminium alloys in additive manufacturing processes involving melting.

The invention finds applications in many industrial fields, and in particular in the automotive and aeronautical fields or else for aluminium alloy structural reinforcement.

### PRIOR ART

In a laser powder bed fusion (LPBF) process, the raw material is in the form of powders and shaping of the alloy is done in a liquid way, by melting the particles of the powders and then by solidifying them, during cooling.

At least for some grades of industrial interest, aluminium alloys having a solidification according to a columnar structure are subject to the hot cracking problem

The aluminium alloy series known to crack during welding are also subject to hot cracking in laser powder bed fusion, like for example the 6061, 7075 or 2024 alloys (references [1], [2], [3], [4] cited at the end of the description). When printing these alloys, large columnar grains oriented according to the construction direction (Z) appear, with cracks propagating along the grain boundaries.

Conventionally, to solve the hot cracking phenomenon, it is known to chemically modify the composition of the aluminium alloy in order to promote, at least locally, an equiaxed type growth (references [2], [3], [5]). The germinating particles or the chemical elements allowing promoting an equiaxed growth are added directly (during the powder atomisation step) or indirectly by coating the aluminium powders with other particles. For illustration, particles containing Zr or Sc and enabling the precipitation of the Al₃Zr/Al₃Sc phases may be added. These phases are known from the literature as excellent refiners for the aluminium phase (reference [6]). Particles known to promote heterogeneous germination of the aluminium phase like CaB₆ (reference [2]) or TiB₂ may also be added (reference [7]).

In the case of the addition of particles containing Zr, it has been shown that the addition of 2% by volume of yttriated zirconia (YSZ) particles to 6061 aluminium alloy particles allows refining the 6061 alloy and completely suppressing cracks (reference [3]).

The increasing addition of an element adding in Zr enables a progressive refinement of aluminium. From 1% by volume of YSZ addition, a bimodal microstructure appears (FIGS. 1A, 1B and 1C). Each melt pool starts to solidify on columnar grains (last grains non-remelted from the previous pool) according to an equiaxed structure. Then very quickly, a columnar growth is observed in the direction of the centre of the pools. However, at 1% by volume, the refinement is not sufficient to cover each melt pool bottom with a complete band of equiaxed grains. A few columnar grains cross one or more pool(s), promoting the initiation and propagation of cracks in these areas, randomly at the printed part level. From 2% by volume, the bottoms of the pools are entirely decorated with equiaxed grains. The width of this band of equiaxed grains increases towards the centre of the pools for the mixture at 4% by volume. The Inventors have shown that grafting of YSZ particles onto aluminium alloy particles allows suppressing hot cracking (reference [8]). However, the relationship with the other parameters of the process, and in particular the cooling rate during the solidification step, has not been studied.

### DISCLOSURE OF THE INVENTION

The present invention aims to provide an additive manufacturing process of the laser powder bed fusion (LPBF) type of parts made of an aluminium alloy allowing overcoming the drawbacks of the prior art.

For this purpose, the present invention provides a process for manufacturing a part made of an aluminium alloy by additive manufacturing comprising the following steps:
a) supplying a powder comprising aluminium alloy particles (Al base), the particles comprising at least 80% by weight of aluminium and up to 20% by weight of one or more additional element(s),
b) depositing a layer of powder over a solid substrate or over an underlying powder layer,
c) locally melting the deposited powder layer by laser beam scanning, so as to form a molten bath, the molten bath comprising a first surface in contact with the substrate or the underlying powder layer, the first surface forming a first solidification surface,
d) cooling the molten bath at a cooling rate Vr so as to solidify it.

Zirconium is added before step c), and preferably before step b), zirconium representing at least 0.7% by weight with respect to the total mass of the aluminium alloy.

The cooling rate Vr at the start of solidification at the first surface of the melt pool is:
lower than a value Vrₘₐₓ defined according to the following equation (1):

$${Vr}_{max} = w * {9.1}^{6} - {4.1}^{6} \qquad ( 1 )$$

with w the percentage by weight of zirconium w with respect to the total mass of aluminium alloy, and
strictly higher than a minimum value Vrₘᵢₙ such that Vrₘᵢₙ=10⁶ K/s.

The invention fundamentally differs from the prior art by the use of a minimum mass amount of added Zr and by the selection of a particular cooling rate adapted to this amount of Zr to implement the process, which allows solving the hot cracking phenomenon.

The Zr released into the bath at the time of the melting step recomposes with the Al to form the germinating phase Al₃Zr.

The Inventors have observed that, for the process according to the invention, the cooling rate at the bottom of the pool influences the formation of an equiaxed structure.

The cooling rate increases starting from the bottom of the melt pool (also called the bottom of the melt pool) towards the centre of the melt pool, i.e. it is lower at the bottom where the equiaxed growth is observed.

The combination of a cooling rate Vr at the start of solidification (for example, lower than 10⁷ K/s at the first surface of the melt pool) and a particular chemical composition in Zr (at least 0.7% by weight) enables a number of germination events (Al₃Zr particles) in the available volume and time period related to this 3D printing process higher than 10⁵, preferably higher than 10⁶. This favours an equiaxed solidification structure over the entirety of the surface at the bottom of the melt pool with grain sizes smaller than 1 μm, preferably 0.7 μm (average diameter).

It is possible to study the thermal conditions allowing estimating the number of these germinating particles using the classical theory of germination. The JVt criterion specifies the number of germination events occurring in a given volume V over a given period of time t (reference [9]). The germination rate J depends mainly on supercooling, measured by the temperature difference between the liquidus of the Al₃Zr phase (which depends on the Zr content in the liquid alloy) and the germination temperature. The available volume V and time period t depend on the used process parameters. These are, respectively, inversely proportional to the thermal gradient at the interface (K/m) and to the cooling rate (K/s).

To guarantee a given number of germination events, it would a priori be possible to think that it is enough to increase the volume V and the time period t appearing in the JVt criterion, but these parameters cannot be set arbitrarily in additive manufacturing, in particular because of the challenges of process productivity and part densification. In addition, the minimum JVt allowing effectively paving the surface of the bottom of the melt pool for the LPBF conditions is also not known from the literature.

However, the Inventors have noticed that it was possible to determine, according to the added amount of Zr, process parameters enabling the germination of a sufficient number of Al₃Zr particles over the first surface at the bottom of the melt pool.

Moreover, because of the very rapid cooling rates used in additive manufacturing (AM) on a powder bed, the theory shows that the incubation time necessary for the formation of seed precursor clusters cannot be neglected, and that, consequently, it is the value of the cooling rate parameter which is the most important process parameter.

The aim being to pave the pool bottoms with an area of equiaxed grains, it would have been logical to think that this objective would have been more easily achievable with large-size equiaxed grains in order to reduce the density of grain boundaries, since it is known from the prior art that cracking occurs at said grain boundaries (reference [1]). Against all expectations, the Inventors have noticed, in particular from TEM analyses, that the grain size had to be smaller than a threshold value (in the range of 1 μm) to succeed in forming a continuous equiaxed zone (i.e. over the entire surface) at the bottom of the pool and thus obtaining a printed alloy free of cracks.

With such a process, it is possible to easily adapt the process parameters to the Zr content used to cover each melt pool bottom with a complete band of equiaxed grains.

The process may be implemented regardless of the means for adding zirconium:
by grafting: the powder supplied in step a) comprises the aluminium alloy particles functionalised by particles containing Zr,
by inclusion at the powder atomisation step: zirconium is added, in a metallic or other form, into the molten bath intended to be atomised.

All these variants allow covering each melt pool bottom with a complete and continuous band of equiaxed grains.

Advantageously, the cooling rate at the start of solidification is higher than 2×10⁶ K/s at the first surface of the solidification front (i.e. at the first surface of the melt pool).

Advantageously, zirconium is added in the form of particles of YSZ, ZrO₂, ZrSi₂ or one of mixtures thereof.

According to a particular embodiment, zirconium is added to the aluminium alloy during a liquid atomisation step.

Advantageously, zirconium represents between 0.7 and 6% by weight, preferably from 0.7% to 3% by weight, even more preferably between 0.7% and 2.4% by weight, with respect to the total mass of the aluminium alloy.

Advantageously, zirconium represents between 1 and 2% by weight with respect to the total mass of the aluminium alloy.

Advantageously, the aluminium alloy is the 7075 alloy, the 6061 alloy, the 2219 alloy or the 2024 alloy.

Both in the variant where Zr is added by grafting and in that where it is included in the Al-based alloy powders at the powder atomisation step, the process has many advantages:
being simple to implement,
being inexpensive, and therefore interesting from an industrial point of view,
being able to easily store/handle powders,
being easily adaptable to any aluminium alloy subject to the problem of hot cracking,
being able to use the parameters conventionally used in additive manufacturing processes.

In the variant where the Zr is added by grafting, an additional advantage is to be able to easily modify the volume ratio between the powders when the powder is mixed.

The invention also relates to a part made of an aluminium alloy obtained by such a process. For example, such a part is made of the 7075, 6061, 2219 or 2024 alloy. The size of the equiaxed grains is smaller than 1 μm, and preferably smaller than 0.8 μm, for example 0.7 μm. These grains form a continuous equiaxed area at the bottom of the melt pool.

Zirconium represents at least 0.7% by weight, and preferably between 0.7 and 6% by weight with respect to the total mass of the aluminium alloy.

Advantageously, zirconium represents between 1 and 2% by weight with respect to the total mass of the alloy.

Advantageously, the part is a heat exchanger.

Other features and advantages of the invention will appear from the following complementary description.

It goes without saying that this complementary description is given only for illustration of the object of the invention and should in no way be interpreted as a limitation of this object.

### BRIEF DESCRIPTION OF THE DRAWINGS

The present invention will be better understood upon reading the description of embodiments given for merely indicative and non-limiting purposes with reference to the appended drawings wherein:

FIGS. 1A, 1B and 1C previously described in the prior art represent captures obtained by electron backscatter diffraction (EBSD) of different printed Al6061+YSZ mixtures in the YZ plane for respectively, 1%, 2% and 4% by volume of YSZ.

FIG. 2 shows the critical cooling rate for the precipitation of the Al₃Zr phase as a function of the percentage by weight of Zr, according to the invention.

FIGS. 3A, 3B, 3C and 3D are TEM images of 6061 alloys obtained either with an addition of 0.6% by weight of Zr (FIGS. 3A and 3C, comparative example) or with an addition of 1.2% by weight of Zr (FIGS. 3B and 3D, according to a particular embodiment of the invention).

FIGS. 4A and 4B show the microstructures of two parts printed by LPBF and obtained from two mixtures made by adding, to Al6061 powders, Zr in the ZrO₂ form corresponding respectively to 0.67% by weight of Zr (comparative example) and 1.29% by weight of Zr (according to a particular embodiment of the invention).

FIGS. 4C and 4D show the microstructures of two parts printed by LPBF and obtained from two mixtures made by adding, to Al6061 powders, Zr in the YSZ form corresponding respectively to 0.6% by weight of Zr (comparative example) and 1.2% by weight of Zr (according to a particular embodiment of the invention).

FIGS. 4E and 4F show the microstructures of two parts printed by LPBF and obtained from two mixtures made by adding, to Al6061 powders, Zr in the ZrSi₂ form corresponding respectively to 0.65% by weight of Zr (comparative example) and 1.21% by weight of Zr (according to a particular embodiment of the invention).

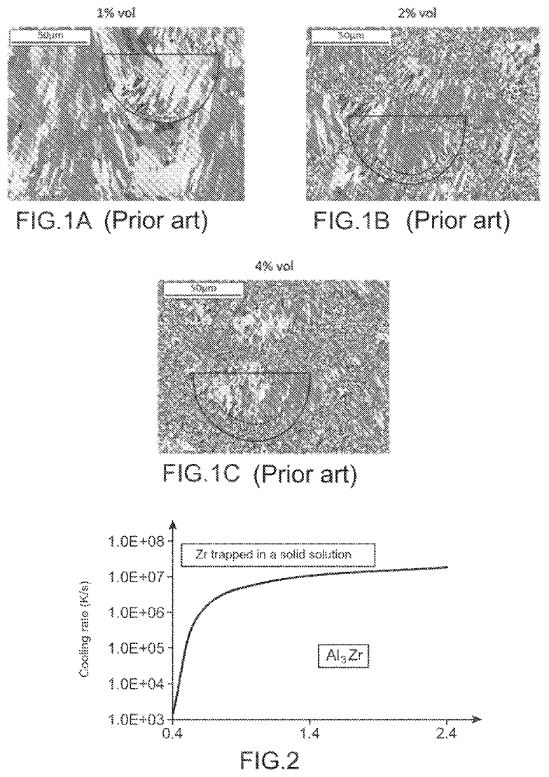

### DETAILED DISCLOSURE OF PARTICULAR EMBODIMENTS

The process for manufacturing a part made of an aluminium alloy by additive manufacturing comprises the following successive steps:
a) supplying a powder of aluminium alloy particles, the particles comprising at least 80% by weight of aluminium and up to 20% by weight of one or more additional element(s),
b) depositing the powder so as to form a layer of powder,
c) locally melting the powder layer, by laser beam scanning, so as to form a molten bath,
d) cooling the molten bath to solidify it, the solidified molten bath being constitutive of the first elements of the parts to be built.

Zirconium is added before step b). Zirconium represents at least 0.7% by weight with respect to the total mass of the alloy.

Preferably, zirconium represents 0.7% to 6% by weight, and even more preferably from 0.7% to 3% by weight with respect to the total mass of the alloy. According to a particularly advantageous embodiment, zirconium represents from 1% to 2% by weight, for example from 1.1% to 1.3% by weight with respect to the total mass of the alloy.

The addition of Zr may be carried out by grafting or inclusion.

Advantageously, in the variant where Zr is added by grafting particles onto the Al-based alloy particles, the particles containing Zr are yttriated zirconia particles (or YSZ, standing for “Yttria-Stabilised Zirconia”), ZrO₂ or ZrSi₂. This may also consist of one of mixtures thereof. For example, this may consist of a mixture of YSZ and ZrO₂, or else a mixture of YSZ, ZrO₂ and ZrSi₂.

Advantageously, when the Al-based alloy particles are functionalised by the particles containing Zr, the Al-based alloy particles and the particles containing Zr are mixed with the 3D dynamic mixer, for example with a Turbula® mixer. Alternatively, this could consist of a mechanical-synthesis process.

According to an advantageous embodiment (grafting), the Al-based alloy particles have a larger dimension ranging from 10 μm to 120 μm and the particles containing Zr have a larger dimension ranging from 5 nm to 6,000 nm and, preferably, from 10 nm to 1,000 nm, even more preferably from 60 nm to 400 nm.

Preferably, the Al-based alloy particles are substantially spherical and their largest dimension is their diameter.

The Al-based alloy particles comprise at least 80% by weight of aluminium, and preferably at least 90% by weight of aluminium.

They may comprise up to 20% and preferably up to 10% by weight of one or more additional element(s) (also called alloy elements). Besides the 0.7% by weight of Zr according to the invention, these elements are preferably selected from among zinc, magnesium, copper, silicon, iron, manganese, titanium, vanadium, bismuth, lead, nickel, zirconium and chromium.

Preferably, the alloy is a 7075 aluminium alloy, a 2024 alloy, a 2219 alloy or a 6061 aluminium alloy.

During step c), a sufficiently energetic beam is used to melt the particles. Thus, a molten bath comprising a first surface and a second surface is obtained. The first surface is in contact with a solid substrate or with the underlying layer of powders. The second surface is a free surface interfacing with the atmosphere of the manufacturing chamber. The two surfaces delimit a volume, called a melt pool.

The deposited layer may be locally molten or completely molten. It is possible to form a molten area or a plurality of molten areas.

The melting step allows creating molten patterns in the layer of the powder mixture. One or more area(s) of molten particles may be made to form the desired pattern. The particles forming the pattern melt down completely so as to lead, upon solidification (step d), to one or more area(s) solidified in an aluminium alloy.

During step d), the cooling rate Vr at the start of solidification at the first solidification surface is both:
lower than a value Vrₘₐₓ represented on the curve given in FIG. 2, obtained from solving the equations of the heterogeneous germination theory. This curve may be approximated by the following equation (1):

$${Vr}_{max} = w * {9.1}^{6} - {4.1}^{6} \qquad ( 1 )$$

with w the percentage by weight of zirconium with respect to the total mass of the aluminium alloy, and
strictly higher than a minimum value Vrₘᵢₙ such that Vrₘᵢₙ=10⁶ K/s.

Preferably, the cooling rate Vr at the start of solidification is lower than 10⁷ K/s at the first solidification surface.

Preferably, the cooling rate Vr at the start of solidification is higher than 2.10⁶ K/s at the first solidification surface.

The cooling rate increases from the first surface (i.e. from the bottom of the pool) towards the second surface (i.e. towards the free surface).

The use of at least 0.7% by weight of zirconium with respect to the total mass of the alloy and of a cooling rate at the start of solidification as defined before at the bottom of the melt pool allows having a sufficient number of germinating Al₃Zr particles for the aluminium phase and therefore an equiaxed growth with a sufficiently fine grain size.

It has been possible to determine the critical cooling rates enabling the germination of a sufficient number of Al₃Zr particles (FIG. 2) using a criterion corresponding to an equiaxed grain size smaller than 1 μm. When the cooling rate of the alloy at the start of solidification in the pool is higher than the critical speed, Zr and Al do not have time to combine. The Al₃Zr seeds do not form and columnar growth is observed.

As illustrated in FIG. 2, with the addition of 0.6% by weight of Zr, the critical cooling rate is close to that at the bottom of the melt pool (reference [9]). As the latter increases when getting to the top of the pool, Zr is quickly trapped in a solid solution. This result is in good compliance with the few equiaxed grains observed at the bottom of the melt pool when 0.6% by weight of Zr is added. On the contrary, when the amount of Zr increases, the critical cooling rate increases enabling the extension of the equiaxed growth towards the middle of the melt pool.

Advantageously, steps b), c) and d) may be repeated at least once so as to form at least one other solidified area on the first solidified area. The process is repeated until the final shape of the part is obtained, the first layer of powder mixture being formed over a substrate (also called a wafer).

For illustration and without limitation, the parameters of the laser powder bed fusion manufacturing process are:
between 50 and 500 W for the laser power,
between 100 and 2,000 mm/s for the laser speed,
between 25 and 120 μm for the distance between two vector spaces (“hatch”),
between 15 and 60 μm for the layer thickness.

The deposition machines used for additive manufacturing processes comprise, for example, a powder delivery system (“Powder delivery system”), a device for spreading and homogenising the surface of the powder (“Roller” or “Blade”), a beam (for example an infrared laser beam at a wavelength of about 1,060 nm), a scanner for directing the beam, and a substrate (also called wafer) which can descend vertically (according to a Z axis perpendicular to the powder bed).

The set may be confined in a thermally closed and inerted enclosure, to control the atmosphere, but also to avoid the dissemination of powders.

Afterwards, the unsolidified powders are evacuated and the final part is detached from the substrate.

The obtained part has a continuity of equiaxed grains having a size smaller than 1 μm, for example 0.7 μm at the bottom of the melt pool.

The part obtained using one of these processes may be subjected to one or more annealing (heat treatment) step(s) to reduce internal stresses and improve mechanical properties.

Although this is in no way limiting, the invention particularly finds applications for structural reinforcement. In particular, the invention finds applications in the energy field, and more particularly, heat exchangers, in the aeronautical field and in the automotive field.

### Illustrative and Non-Limiting Examples of One Embodiment:

The process consists of two steps.

First of all, a cracking aluminium alloy powder with a size comprised between 1 and 100 μm is chemically modified, for example by adding 0.6% by weight and 1.2% by weight of Zr to an Al6061 powder.

Once this step is completed, the powder may be printed in a laser powder bed fusion (LPBF) machine. In this example, to obtain a complete equiaxed band at the bottom of each melt pool with a grain size smaller than 1 μm and a good densification of the produced parts, the used LPBF conditions are:
Laser power: 100-500 W, for example 216 W,
Laser speed: 100-2,000 mm/s, for example 700 mm/s,
Vector space: 50-150 μm,
Layer thickness (powder bed): 20-60 μm.

For illustration, for the following experimental conditions: pair 216 W, 700 mm/s, vector space of 100 μm and thickness 20 μm, the cooling rate is strictly higher than 10⁶ K/s (for example 1.2×10⁶K/s) at the bottom of the melt pool and evolves up to 3×10⁷ K/s at the top surface.

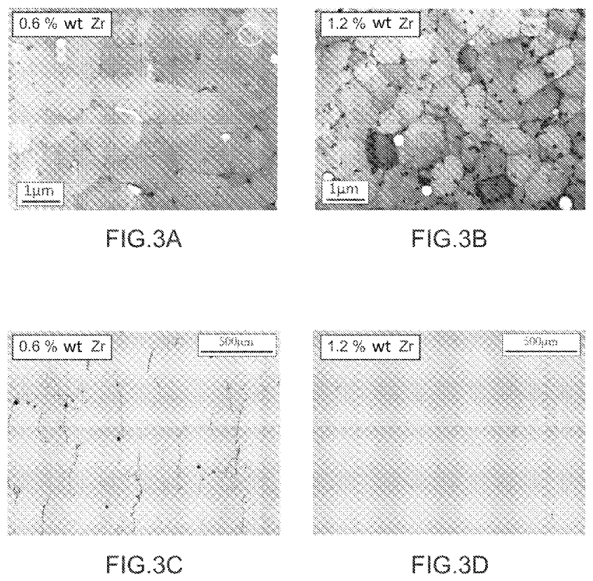

With an addition of 0.6% by weight of Zr, cracks are still present, the size of the equiaxed grains remains too large (FIGS. 3A and 3C). Their average diameter, determined by the intercepts method, is 1.2 μm.

At 1.2% by weight of Zr, the critical cooling rate for the germination of Al₃Zr increases, enabling an increase in the density of seeds at the bottom of the melt pool, and therefore a decrease in the size of the equiaxed grains (0.6-0.7 μm). In fine, at 1.2% by weight cracks are no longer observed (FIGS. 3B and 3D).

It was not obvious that under such cooling conditions and with such low amounts of added Zr, Al₃Zr particles would have time to form.

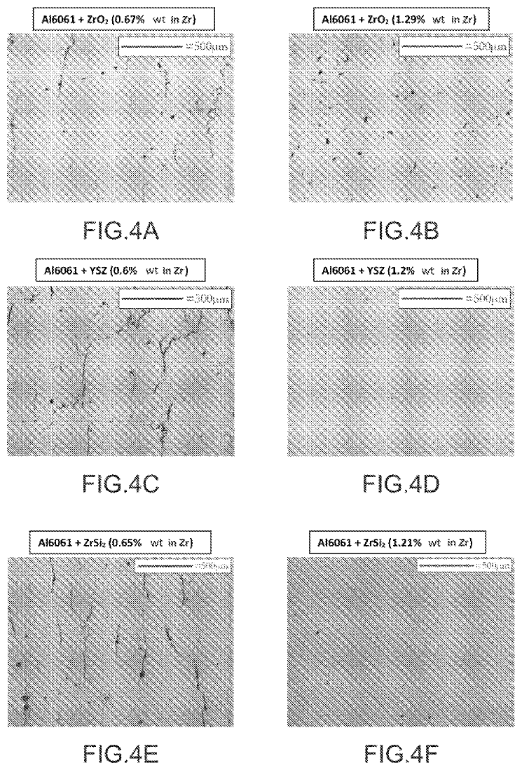

In order to prove that one of the key parameters controlling the resolution of the hot cracking phenomenon in LPBF is the amount of Zr, FIG. 4 group together the microstructures of six mixtures made with three particles containing Zr (YSZ, ZrO₂ and ZrSi₂) in different amounts and printed by LPBF (FIGS. 4A to 4F).

Regardless of the chemical nature added to the 6061 powder, mixtures containing less than 0.7% by weight of Zr crack. Beyond 0.7% by weight, and more particularly beyond 1% by weight, cracks are no longer observed.

### REFERENCES

[1] Sonawane, A. et al., 2021. Cracking mechanism and its sensitivity to processing conditions during laser powder bed fusion of a structural aluminium alloy. Materialia 15, 100976. https://doi.org/10.1016/j.mtla.2020.100976
[2] Mair, P. et al., 2021. Laser powder bed fusion of nano-CaB6 decorated 2024 aluminium alloy. Journal of Alloys and Compounds 863, 158714. https://doi.org/10.1016/j.jallcom.2021.158714
[3] Opprecht, M. et al., 2020. A solution to the hot cracking problem for aluminium alloys manufactured by laser beam melting. Acta Materialia 197, 40-53. https://doi.org/10.1016/j.actamat.2020.07.015
[4] Kaufmann, N. et al. 2016. Influence of Process Parameters on the Quality of Aluminium Alloy EN AW 7075 Using Selective Laser Melting (SLM). Physics Procedia 83, 918-926
[5] Montero-Sistiaga, M. L., et al., 2016. Changing the alloy composition of A17075 for better processability by selective laser melting. Journal of Materials Processing Technology 238, 437-445
[6] Wang, F. et al., 2014. Crystallographic study of Al₃Zr and Al₃Nb as grain refiners for Al alloys. Transactions of Nonferrous Metals Society of China 24, 2034-2040
[7] FR3075828 A1
[8] FR3096056 A1
[9] Klein, S., Herlach, D. M., 2013. Crystal nucleation in undercooled melts of PdZr₂. Journal of Applied Physics 114, 183510. https://doi.org/10.1063/1.4829903

What is claimed is:

1. A process for manufacturing a part made of an aluminium alloy by additive manufacturing comprising the following steps:
a) supplying a powder comprising aluminium alloy particles, the particles comprising at least 80% by weight of aluminium and up to 20% by weight of one or more additional element(s),
b) depositing a layer of powder over a solid substrate or over an underlying powder layer,
c) locally melting the deposited powder layer by laser beam scanning, so as to form a molten bath, the molten bath comprising a first surface in contact with the substrate or the underlying powder layer,
d) cooling the molten bath at a cooling rate Vr so as to solidify it,
wherein zirconium is added before step c), and preferably before step b), zirconium representing at least 0.7% by weight with respect to the total mass of the aluminium alloy,
and in that the cooling rate Vr at the start of solidification at the level of the first surface of the molten bath is:
lower than a value Vrₘₐₓ defined by the following equation (1):
$${Vr}_{max} = w * {9.1}^{6} - {4.1}^{6} \qquad ( 1 )$$
with w the percentage by weight of zirconium with respect to the total mass of aluminium alloy, and
strictly higher than a minimum value Vrₘᵢₙ such that Vrₘᵢₙ=10⁶ K/s.

2. The process according to claim 1, wherein the cooling rate at the start of solidification is higher than 2×10⁶ K/s at the first surface of the molten bath.

3. The process according to claim 1, wherein the powder supplied in step a) comprises the aluminium alloy particles functionalised with particles containing Zr.

4. The process according to claim 1, wherein zirconium is added in the form of YSZ, ZrO₂, ZrSi₂ particles or one of mixtures thereof.

5. The process according to claim 1, wherein zirconium is added to the aluminium alloy during a liquid atomisation step.

6. The process according to claim 1, wherein zirconium represents between 0.7 and 6% by weight with respect to the total mass of the aluminium alloy.

7. The process according to claim 1, wherein zirconium represents between 0.7 and 3% by weight with respect to the total mass of the aluminium alloy.

8. The process according to claim 1, wherein zirconium represents between 1 and 2% by weight with respect to the total mass of the aluminium alloy.

9. The process according to claim 1, wherein the aluminium alloy is 7075 alloy, 2219 alloy or 2024 alloy.

10. The process according to claim 1, wherein the aluminium alloy is 6061 alloy.

11. A part made of an aluminium alloy, preferably 7075, 6061, 2219 or 2024 alloy, obtained by the process according to claim 1, zirconium representing at least 0.7% by weight with respect to the total mass of the aluminium alloy, the size of the equiaxed grains being smaller than 1 μm.

12. The aluminium alloy part according to claim 11, wherein the size of the equiaxed grains is smaller than 0.8 μm.

13. The aluminium alloy part according to claim 11, wherein the aluminium alloy is the 6061 alloy.
